(19) United States
(12) Patent Application Publication
(10) Pub. No.: US 2009/0230369 A1
(43) Pub. Date: Sep. 17, 2009

(54) TOOL FOR REMOVAL OF CENTER COVER OF A WHEEL RIM

(75) Inventor: Scotty R. Kurtz, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 12/046,081

(22) Filed: Mar. 11, 2008

(51) Int. Cl. B66F 15/00

(52) U.S. Cl. 254/131

(57) ABSTRACT

A tool for removal of a center cover of a wheel rim includes a first and second opposite hook ends connected by a cylindrical rod center section. Each of the hook ends is differently sized, although the ends are generally mirror image configurations of one another and each includes first and second curved sections joined to an extended flat, planar section with an end prong.

### BACKGROUND OF THE INVENTION

In a principal aspect the present invention relates to a tool which is designed to facilitate the removal of a center cover of a wheel rim of a motor vehicle, or alternatively, the hub cap cover at the center of a wheel rim.

Many modern motor vehicles include a wheel rim wherein the spokes of the wheels are visible, but the center of the wheel rim, which is attached by lug nuts to a wheel axle, are not exposed, but are, in fact, covered by a center cover. This center cover or hub cover or cap is typically retained on the wheel rim by a detent mechanism which enables snapping of the hub cover onto the wheel rim. Multiple designs of such hub covers, or center covers, are or have been adopted for motor vehicles.

When servicing a vehicle, it is often necessary to remove the wheel, for example, to replace the tire or to have access to the outer end of the axle. As a first step in such servicing, it is typically necessary to remove the hub cover or hub cap. Such removal may be effected by means of the blade of a screwdriver. The blade is used to pry the hub cover from the wheel rim. The utilization of a screwdriver or similar tool may result in scratching of the wheel cover.

There are other specialty tools available in the marketplace which may be used for such a purpose. Typically, for example, center cap removers or wheel cover pullers are available from Ken-Tool, Model Nos. T67, T68, T65, T66 and as a set of such tools. These tools typically utilize a screwdriver type handle which is attached to a rod with a blade fashioned at the end of the rod for engaging and pulling the wheel cover or center cap from a wheel rim. These prior art tools require multiple variations and sizes of such tools in order to achieve the desired capability of providing a cover removal tool which is useful with respect to multiple types of wheel covers or caps. Thus, there has developed the need for an improved center cover or hub cap puller.

### SUMMARY OF THE INVENTION

Briefly, the present invention comprises a tool for removal of the center cover of a wheel rim. The tool is comprised of a unitary, elongate, generally cylindrical rod having a first hook end and an opposite hook end with a straight connecting cylindrical rod section joining the hook ends. The hook ends are each fashioned with a similar configuration, but have a different size and different orientation. Thus, each hook end is comprised of a series of first and second oppositely radiused bends which terminate with a flat-sided blade extension with an end prong. An important feature of the tool is the universality of the tool inasmuch as the opposite hook ends are appropriately sized and dimensioned and configured to enable utilization of the tool with almost any wheel cover or hub center cover. Additionally, the hook ends and the center connecting section all lie in the same plane though the blades and the end of the hook ends extend in opposite directions. This facilitates manipulation of the tool.

Thus, it is an object of the invention to provide a tool for removal of center caps from wheel rims.

A further object of the invention is to provide a tool which has universal utility in that it is useful with the design of multiple types of center caps and wheel or rim constructions.

Another object of the invention is to provide a center cap which is designed to minimize the possibility of scratching or marring either the rim or the center cap associated with a rim of a motor vehicle wheel.

Another object of the invention is to provide a tool for removal of the center cap or hub cap from a wheel of a motor vehicle which is easy to use, inexpensive, rugged, and highly utilitarian.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a side elevation of the tool of the invention;

FIG. 2 is a further side elevation of the tool of FIG. 1 as viewed 90° from the view of FIG. 1;

FIG. 3 is an isometric view of the tool of FIG. 1;

FIG. 4 is an isometric view of the manner in which the tool of FIG. 1 is utilized;

FIG. 5 is a further isometric view of the tool of FIG. 1 as used with a distinct center cover or hub cap cover; and

FIG. 6 is another example of an isometric view of the use of a tool of FIG. 1 and FIG. 3.

### DESCRIPTION OF AN EMBODIMENT OF THE INVENTION

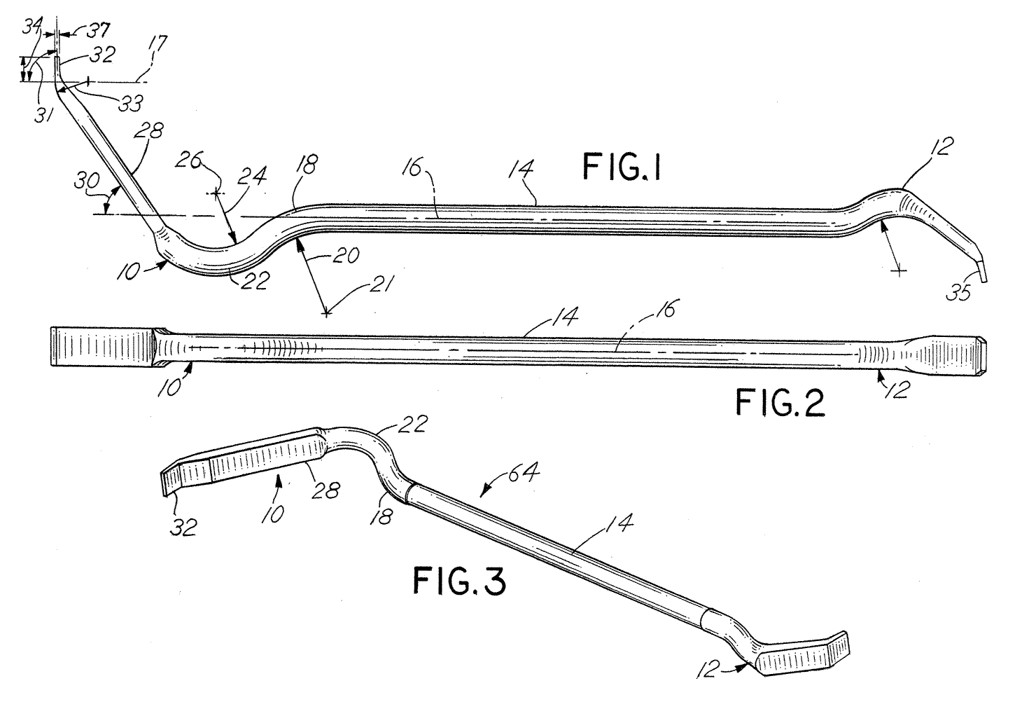

Referring to the figures, the tool of the invention is comprised of a unitary, elongate, generally cylindrical rod. The cylindrical rod includes a first hook end 10, an opposite or second hook end 12, and a connecting section 14 joining the first end 10 and the second end 12. The first end 10 and the second end 12 all lie in a plane or are coplanar with the connecting rod section 14 so that the tool may lay flat on a flat, planar surface when viewed as depicted, for example, in FIG. 2. The connecting section 14 is a cylindrical rod having a diameter in the range of 0.25 to 0.5 inches. The length of the connecting section 14 is in the range of 6-8 inches. Connecting section 14 includes a straight, center line axis 16. The opposite first and second ends 10, 12 each follow generally arcuate pathways and are integrally joined to the center connecting section 14.

Thus, the connecting section 14 defines a straight, longitudinal axis 16. The first hook end 10 and second hook end 12 are each formed to include curved sections or curved extensions therefrom. A first curve section 18 of the first hook end 10 has a radius 20 with the center 21 of the first arcuate or curve section 18 beneath or on a first side of the longitudinal axis 16 in FIG. 1. The first curve section 18 joins to a second arcuate or curve section 22 which has a radius 24 centered on center 26 wherein the center 26 of the radius 24 is on the opposite side of the longitudinal axis 16 from center 21. Thus, the first radius curve section 18 is centered on a side of the axis 16 opposite from the center 26 of radius 24 of the second curved section 22.

The second curved section 22 extends or merges into a tangential run and generally straight section 28 which has parallel, flat, planar sides generally parallel to a flat plane that would support the tool as positioned in FIG. 2. Run or section 28 forms an angle 30 of about 55° (in the range of 25°-60°) with axis 16. The flat, planar section 28 extending at the angle 30 from the axis 16 terminates with a flat-sided prong or tip 32 forming an angle 31 in the range of 80°-100° with respect to an axis 17 parallel to axis 16. The blade 32 thus forms an angle with the flat, planar section or run 28 and extends therefrom a distance of 0.28 to 0.36 inches. The tip, prong or blade 32 has a thickness in the range of 0.03 to 0.06 inches. The entire length of the first hook end 10 is in the range of 3 to 5 inches as measured along the curved longitudinal extent of the first hook end 10.

The structure and dimensions of tips or blades 32 and 35 are an important feature. The thickness 37 is in the range of 0.030 to 0.080 and desirably about 0.050 inches. The outside length 34 is about 0.28 to 0.36 inches, desirably 0.32 inches. The outer radius 33 of the surface between blade 28 and tip 32 is very important in order to enable application of proper leverage by means of the tool and is set forth in the table.

The second hook end 12 is a smaller sized version of the first hook end 10 and has a configuration substantially the same as the first hook end 10, but having a length of about 0.45 to 0.80 times, the actual length of the first hook end 10. Thus the arcuate characteristics of the second hook end are reduced generally proportionally relative to the first hook end 10. However, the width, thickness and length of a tip 35 are generally the same as tip or blade 32. Further, the second hook end 12 is oriented in the opposite sense from the first hook end 10.

In review, each hook end 10 and 12 includes a first, curved section, such as section 18, joined to a second oppositely curved section, such as section 22, joined to a flat, planar section 28 and then to an end tip or blade prong 32, 35. The inclusion of the four component parts in the first hook end 10 is considered to be an important feature of the invention in order to enable successful manipulation of the tool for removing various sizes of hub cap covers or center covers of wheel rims. Note that the hook ends 10, 12 are coated with a polyvinylchloride (PVC) layer to avoid scratching of the rim or the cover that is to be removed.

Referring to FIG. 1, the dimensional characteristics of an embodiment of the invention are set forth in Table 1. Table 1 further sets forth the preferred limits of the various dimensional characteristics. It is to be noted that the first hook end 10 and the second hook end 12 each have a similar configuration and they are joined by straight, connecting center rod section 14 and that tips 32, 35 are substantially the same.

TABLE 1

| | NOMINAL | |
|---|---|---|
| ITEM | DIMENSION | RANGE |
| 10 - First End | 4″ | 3″-5″ |
| 12 - Second End | 2.5″ | 2.0″-3.0″ |
| 14 - Center Section | 5.87″ | 5″-7″ |
| 20 - Radius | 1.00″ | .8″-1.2″ |
| 24 - Radius | .600″ | .56″-.66″ |
| 30 - Angle | 55° | 35°-60° |
| 31 - Angle | 90° | 80°-100° |
| 33 - Radius | .19″ | .16″-.21″ |
| 34 - Tip Length | .32″ | .28″-.36″ |
| 37 - Tip Thickness | .050″ | .030″-.080″ |
| 36 - [?] | .43″ | .40″-.50″ |

FIGS. 4, 5 and 6 illustrate the use of the tool with various types of center rim covers. Referring to FIG. 4, a rim 60 includes a center cover 62. Tool 64 and, in particular, the prong 32 at hook end 10, is fitted under the edge of the cover 62.

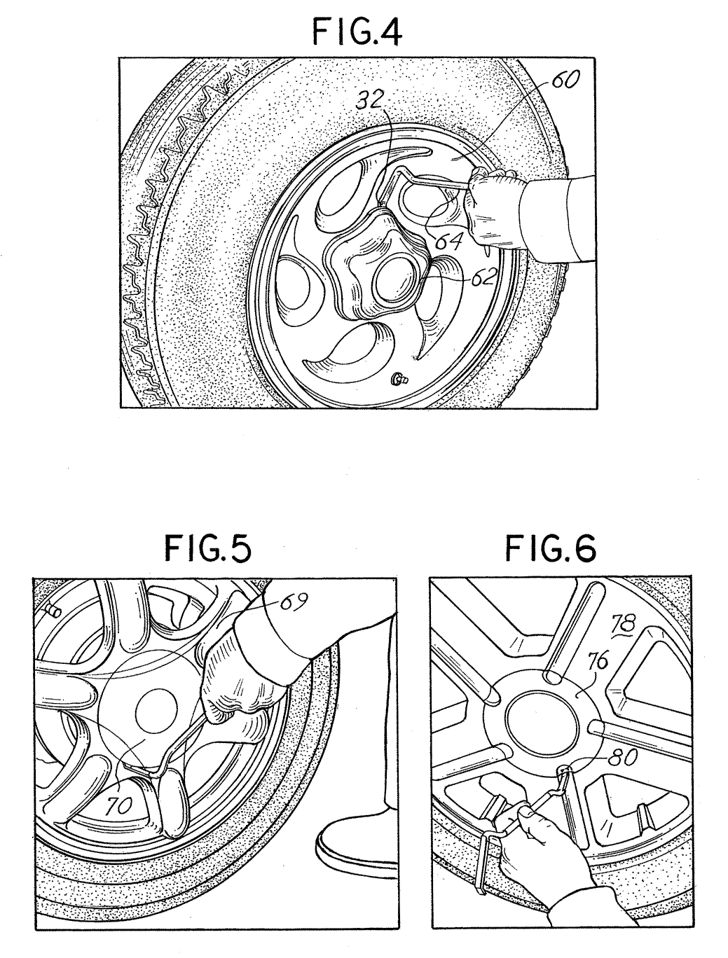

FIG. 5 shows an alternative center cover construction wherein a rim 69 is designed with a recessed wheel cover 70. The prong 32 is fitted in a slot between the cover 70 and the rim 69 to effect removal.

FIG. 6 shows the use of the tool for the removal of a recessed center cover 76 associated with the rim 78. The small, reduced sized second hook end 12, prong 40 is fitted into a slot 80 between the rim 78 and the wheel cover 76 to effect removal of the wheel cover 76.

While there has been set forth an embodiment of the invention, it is to be understood that the invention is to be limited only by the following claims and equivalents thereof.

1. A tool for removal of a center cover of a wheel rim comprising:
a unitary, elongate, generally cylindrical rod having a first hook end, an opposite second hook end, and a straight connecting cylindrical rod section unitary with and joining the first hook end to the second hook end, said connecting section defining a longitudinal axis, said first hook end, second hook end and connecting section configured to be coplanar;
said first hook end with a first curve section having a first radius centered in said plane and spaced from the axis in a first direction and joined to the connecting section, a second curve section extending from the first section, centered in said plane spaced from said axis in a second direction opposite the first direction and joined to a straight run in the form of a flat sided blade forming an angle with the axis in the range of 25° to 60°, said straight run extending from one side of the axis to the opposite side of the axis, said flat-sided blade in the range of 0.28 to 0.36 inches in length, said straight run connected to a flat-sided, terminating prong forming an angle in the range of 80° to 100° with the axis, said terminating prong having a thickness in the range of 0.03 to 0.08 inches, said first hook having an axial extent in the range of 3 to 5 inches; and
said second hook end comprising a proportionally lesser length and generally mirror image configuration of said first hook end and having an axial extent of about 0.45 to 0.8 the axial extent of said first hook end.

2. The tool of claim 1 wherein the first hook end and second hook end are each coated with an organic material coating.

3. The tool of claim 1 wherein the cylindrical connection section has a diameter in the range of about 0.25 to 0.5 inches.
